(19) United States
(12) Patent Application Publication
(10) Pub. No.: US 2026/0257770 A1
(43) Pub. Date: Sep. 3, 2026

(54) TENDON FOR A TENSION LEG PLATFORM AND TENSION LEG PLATFORM INCLUDING SUCH TENDON

(71) Applicant: Cabin Air Group B.V., Joure (NL)

(72) Inventor: Rinze Jan VAN DER SCHUIT, Oranjewoud (NL)

(73) Assignee: Cabin Air Group B.V., Joure (NL)

(21) Appl. No.: 19/163,053

(22) PCT Filed: Mar. 7, 2024
(86) PCT No.: PCT/NL2024/050107

§ 371 Date: Sep. 8, 2025

(30) Foreign Application Priority Data
Mar. 13, 2023 (NL) 2034334

(51) Int. Cl. B63B 21/50; B63B 35/44; F03D 13/20; F03D 13/25; F16G 11/05; F16G 11/14

(52) U.S. Cl. CPC B63B 21/502; B63B 35/44; F03D 13/2005; F03D 13/25; F16G 11/05; F16G 11/146; B63B 2035/446; F05B 2240/95

(57) ABSTRACT

A tendon (224) for a tension leg platform (202), TLP, is provided. The TLP has a foundation (206), connectable to a bottom (208) of a body of water, and a buoyant hull (216). The tendon has a length of at least 300 meters, a proximal end (223), and a distal end (225). The tendon also has a proximal end fitting at the proximal end and a distal end fitting at the distal end. The tendon is connectable with the proximal end fitting to the hull and with the distal end fitting to the foundation to provide a pulling force on the hull. The tendon is formed with basalt fibres for transferring the pulling force from the proximal end fitting to the distal end fitting.

### CROSS REFERENCE TO RELATED APPLICATIONS

This application is a national stage application (under 35 USC § 371) of PCT/NL2024/050107, filed Mar. 7, 2024, which claims benefit of NL 2034334, filed Mar. 13, 2023, the contents of each of which is incorporated by reference herein.

### BACKGROUND OF THE INVENTION

The invention relates to a tendon for a tension leg platform and a tension leg platform.

A tension leg platform of this type is used as support for offshore activities such as the production of oil or gas. A relative new use which is currently being explored is for offshore wind turbines.

A tension leg platform (TLP) of this type is known from US-2013/183163-A1 (US'163). US'163 discloses a TLP wind turbine with a central body of hollow steel construction which comprises a lower axial cylindrical tubular float surmounted by a group of upper coaxial cylindrical tubular sections on top of which is a coaxial cylindrical tubular tower of smaller cross-section. Atop of the tubular tower is a yaw housing carrying a conventional wind turbine. Connected to and evenly radially spaced around the central float body are eight horizontal steel outrigger arms, the distal ends of which are interconnected by a ring of horizontal steel braces. Each carries a connection to the upper end of a respective flexible steel tether running down to a counterweight on the seafloor. US'163 describes as a possible variant that the tethers may be made of Kevlar™. It is noted that US'163 uses the terms ‘float’ and ‘tether’, while the current specification refers to the terms ‘hull’and ‘tendon’, respectively.

A TLP provides a relative stable support for offshore activities, as it minimizes vertical motions which are usually induced on floating bodies. However, a disadvantage of the known TLPs in greater water depths is that the motions, in particular roll and pitch motions, which are relatively small at the level of the water level, cause a relatively large swaying motion at the top of tall operational structures. Such a large motion is unacceptable for certain applications. This is in particular a problem for wind turbines, because they require a tall tower to accommodate a large rotor, while the rotor itself can withstand only a small amount of motions.

It is the common opinion of experts in the field that a TLP is only suitable for wind turbines in relatively small water depths. As stated on the English language page on ‘Tension-leg platform’ on Wikipedia (version as available on the filing date of the current application): ‘researchers estimate they [TLP with wind turbines] can operate in depths between 100 and 650 feet (200 m)’.

The invention aims to solve at least one of these problems, or at least to provide an alternative. In particular, the invention aims to provide a tendon for a tension leg platform that reduces roll and pitch motions of TLPs in greater water depths.

### SUMMARY OF THE INVENTION

A tendon is designed for a tension leg platform comprising a foundation and a buoyant hull. The foundation is connectable to a bottom of a body of water, e.g. the seabed or seafloor. The tendon has a length, a proximal end, and a distal end. The tendon comprises a proximal end fitting at the proximal end and a distal end fitting at the distal end. The tendon is connectable with the proximal end fitting to the hull of the TLP and with the distal end to the foundation of the TLP to provide a pulling force on the buoyant hull. The length of the tendon is at least 300 meters. The tendon comprises basalt fibres for transferring the pulling force from the proximal end fitting to the distal end fitting.

The invention is based on the insight that para-aramid fibres, such as the fibres marketed under the trademarks Kevlar™ described in US'163, despite theoretically being able to provide the required strength, have an inherent problem when used as load bearing fibre for a relatively long tendon. The problem which the inventor has discovered is that a relatively long para-aramid tendon will show too much elongation under stress, resulting in roll and pitch movements in the topside structure of the TLP of a magnitude which is unacceptable for certain applications, such as wind turbines. An obvious solution would appear to increase the diameter of the tendon by adding more fibres, as the stiffness is determined by E·A, with E being the Young's modulus and A the cross sectional surface area. The inventor of the current invention has discovered that increasing the diameter does not solve the problem, as para-aramid fibre has non-linear material properties: the Young's modulus is not constant at relative low stress values. Adding more fibres to the tendon, with the aim to increase the stiffness, will result in a lower stress per fibre and thus in a decrease of the Young's modulus. This decrease has been discovered by submitting a series of para-aramid cables with increasing diameter to the standard ASTM D7269 test, and calculating the Young's modulus from the test results. The observed decrease in Young's modulus outweighs the increase in surface, so that the total stiffness E·A will not reach the required value. The inventor has found that basalt fibres do hardly show any of this non-linear effect at lower stress values. Basalt fibres already reach approximately 95% of their maximum Young's modulus at low stress values. Therefore, one can add as many fibres as needed to obtain the required stiffness. An additional advantage of basalt compared to para-aramid fibres, is that a tendon made of basalt fibres, with a comparable stretch, is approximately 2.5 times less expensive.

It is noted that another fibre type which can provide the strength that is required for a tendon is ultra-high molecular weight polyethylene (UHMwPE, sold under the trade mark Dyneema®). However, the Young's modules of this fibre type is much lower than that of basalt fibres, while the cost of this fibre type would result in a price for a tendon of approximately 2.8 times the price of a tendon made of basalt with the same stretch. The high cost of UHMwPE fibres would result in a total cost for tendons for deeper water conditions which is higher than the cost of the TLP and wind turbine combined. UHMwPE is therefore not an economical solution to the above described problem.

Preferred embodiments are defined in the dependent claims and the following paragraphs.

In a particular embodiment, the length of the tendons is at least 400 meters, more in particular at least 500 meters, more in particular at least 700 meters, more in particular at least 1000 meters.

As set out above, the invention enables the use of TLPs at depths of more than 300 meter, even up to 1000 meter. Such depths were previously unfeasible with conventional tendons of e.g. Kevlar™.

In an embodiment, the basalt fibres extend parallel to each other in the longitudinal direction of the tendon.

Arranging the basalt fibres in parallel in the longitudinal direction of the tendon aligns the fibres with the tensile load that is exerted on them during use. This ensures that the load bearing capacity of the fibres is fully used, or at least close to being fully used. In addition, providing the fibres in parallel to each other reduces friction between the fibres, thereby reducing abrasion of the fibres and extending the life span of the tendon.

In an embodiment, the basalt fibres are untwisted.

Fibres in a rope can be twisted on several levels: within a yarn, for forming a sub-rope, and by combining the sub-ropes into one rope or cable. The term ‘untwisted’ in the context of the current invention applies to all these levels. By providing untwisted fibres, friction between fibres is reduced. This reduces abrasion of the fibres and thus extends the life span of the tendon.

In an embodiment, the tendon comprises a plurality of yarns. The yarns comprise the basalt fibres. Each of the plurality of yarns has a length which corresponds to the length of the tendon. Each yarn has a proximal yarn end which is connected to the proximal end fitting and a distal yarn end which is connected to the distal end fitting.

The length of the yarns corresponds to the length of the tendon, i.e. the length of the yarns is substantially the same as the length of the tendon, with less than 1% difference. The tendon as a whole may be slightly longer than the yarns, e.g. due to the end fittings extending a few centimetres or decimetres beyond the ends of the yarns.

The tendon is at least 300 meters, in particular at least 400 meters, more in particular at least 500 meters, more in particular at least 700 meters, more in particular at least 1000 meters. By providing yarns of corresponding length, the tendon can be produced with minimal fiber lengths, e.g. as compared to winding the fibers between the two end fittings.

In an embodiment, at least one of the distal end fitting or proximal end fitting comprises a hollow part that has a cavity of which the width increases towards the respective end of the tendon, wherein the yarns extend into the cavity of the hollow part and diverge inside the cavity.

At each end of the tendon, the yarns of basalt fibres diverge such that spacing is provided in between the yarns. In contrast, in the bulk of the tendon extending between the end fitting, the fibres are packed more closely together. The divergence of the yarns arrests the yarns within the cavity of the end fitting.

In an embodiment, the cavity comprises a frustoconical shape.

The frustoconical shape closely follows the yarns as they gradually fan out, thus ensuring that the cavity wall remains close to or even touches the outer yarns. In other words, the frustoconical shaped cavity closely matches the volume taken up by the diverging yarns. This means that less adhesive or resin is required to fill the cavity, e.g. as compared to a rectangular cavity.

In an embodiment, the cavity is filled with a matrix that fixates the diverging yarns. The yarns and the matrix form a plug that locks the yarns in the end fitting. The matrix used to fixate the diverging yarns is for example a resin, such as an epoxy resin.

In an embodiment, an arresting body is provided in the cavity that keeps the diverging yarns spaced apart, the arresting body having a shape that is complementary to a shape of the cavity. In particular, a matrix, resin, or adhesive is provided to connect the yarns with the arresting body and/or the surface of the cavity, and/or to fill remaining cavities between the diverging yarns.

For example, in an embodiment with a frustoconical cavity, the arresting body has wedge shape. In particular, the arresting body has a frustoconical or conical shape. The arresting body contributes to locking the yarns in their spaced apart configuration. In addition, less matrix, resin or adhesive is required to fixate the yarns, as the arresting body fills up part of the volume of the cavity.

In an embodiment, the tendon is formed by pultrusion to bundle the basalt yarns with a cover, in particular a polymer cover.

The polymer may for example comprise a thermosetting polymer, such as polyvinyl chloride (PVC). In particular, sub ropes are formed by pultrusion of a plurality of parallel basalt yarns that are arranged parallel to each other, and the sub ropes are bundled parallel to each other to form the tendon.

In an embodiment, the tendon comprises at least one yarn which comprises basalt fibres. The proximal end fitting comprises a first thimble and the distal end fitting comprises a second thimble. The first thimble and the second thimble are provided at opposite ends of the tendon. The at least one yarn extends from the first thimble to the second thimble, turns around the second thimble, extends from the second thimble to the first thimble, and turns around the first thimble. In this arrangement, the yarn forms turns around the first and second thimbles and each thimble holds a stack of a plurality of layers of turns of the yarn.

Within the context of this document, a ‘thimble’ is defined as a ring of any shape and made of any material around which the at least one yarn is turned. Within the context of this document, a ‘turn’ of a yarn may be either a semi-continuous loop, or a continuous loop. The term ‘semi-continuous loop’ refers to the fact that the yarn has a finite length with distinct ends, while in a ‘continuous loop’ a yarn has no ends. So in a semi-continuous loop, the at least one yarn is wound around the first and second thimble a plurality of times, forming a plurality of loops around these thimbles, which is not completely continuous as the ends of the yarn are not connected to each other.

Each thimble holds a stack of layers of turns of the at least one yarn.

In an embodiment, an adhesive is provided at at least one of the first and second thimble only and mutually connects at least two of the plurality of layers of turns of the yarn in the stack of the respective first or second thimble to retain a tangential orientation of the respective yarn layers with respect to each other when the tendon is subject to a load. The stack of the plurality of turns of the yarns of each thimble engages the respective thimble along a part of the respective thimble's circumference. The adhesive that is provided at said at least one of the first and second thimble extends over at least a portion of said circumferential part of the respective first or second thimble.

The adhesive is provided in a respective yarn layer at one of the thimbles only, or to both of the thimbles only, and not to the yarns between the end fittings along the full length of the tendon, or to the yarns between the end fittings without curing the adhesive, such that the part of the tendon extending between the end fittings remains flexible. The phrase ‘an adhesive is provided at at least one of the first and second thimble only’is interpreted within the context of this specification accordingly.

Providing and curing an adhesive to the yarns over the full length of the tendon would result in a stiff rod instead of a tendon with some flexibility. Some flexibility of the tendon is desirable e.g. for rolling up or folding the tendon for transport.

Since the yarns turn around the thimbles, each thimble supports the yarns only along a part of its circumference, while the yarns are not supported along another part of the thimble's circumference. The adhesive extends over at least a portion of the circumferential part of the thimble that supports the yarns. Preferably, no adhesive is applied to the yarns in a part of the end fitting where the yarns are not supported by the thimble.

Additional layers of yarns also may comprise adhesive to connect yarns of such layers together within a respective stack. In a particular example, substantial all layers in the at least one of the thimbles are connected by the adhesive.

In an embodiment, the adhesive extends over a portion of the circumferential part only. In particular said portion is centred about the longitudinal axis of the tendon.

For example, the adhesive extends over less than 50% of the circumferential part, e.g. less than 25% of the circumferential part, in particular less than 10% of the circumferential part. The adhesive extends over more than 1% of the circumferential part, in particular more than 2% of the circumferential part, more in particular more than 5% of the circumferential part.

When a tendon is rolled up or folded for transport, fibres on the radial outer side of the roll are subject to stress while fibres on the radial inner side of the roll are compressed. This results in a slight shift of the yarn layers with respect to each other in the stacks of one or both thimbles. This shifted position may remain at least partly after the tendon is unrolled, resulting in an unequal length of the fibres, which in turn results in an uneven load on the fibres when the tendon is subjected to a load. As basalt fibres have a relatively high Young's modulus, this results in a part of the yarns being subject to less load than designed and another part being subject to a higher load than designed, resulting in a premature failing of yarns in the higher loaded part. Connecting at least two layers together using an adhesive prevents relative movement of these layers and thus prevents unequal load of the yarns on one side of the tendon with respect to the yarns on the other side. The adhesive is applied at least to a central portion of the circumferential part of the thimble that supports the yarns, which suffices to prevent the shifting caused by rolling up the tendon, while the cost of applying the adhesive to the central portion only is less than applying it to the full circumferential part.

In another embodiment, the adhesive extends over the entire circumferential part of the thimble that supports the yarns.

In addition to preventing shifting of the yarns when rolling up the tendon, application of the adhesive over the entire circumferential part of the thimble that supports the yarn further prevents relative movement of the layers when subjected to load cycles. The length of the yarn in the thimble is larger in an outer layer of turns of the yarn than in an inner layer of turns. While this difference in length is small in an absolute sense from one layer to a next layer, it does result in a different elongation of the yarn under load, because the amount of elongation corresponds to the length of the yarn, for a given Young's modulus and cross section of, and tension in, the yarn. When a tendon is subject to load cycles by repeatedly increasing and decreasing of a pull load on the thimbles, the difference in elongation results in a reciprocating movement of each layer of turns of the yarn with respect to the neighbouring layers. This movement causes micro abrasion of the yarns. A further failure mechanism which is also caused by load cycles is that the stack of yarn layers is slightly compressed because the longitudinal stress in each of the yarn layers is transferred to the thimbles as a pressure in a radial inward direction via intermediate yarn layers. This inward directed pressure results in a slight compression of the intermediate layers, which results in a reciprocating movement of outer yarn layers with respect to inner yarn layers, and thus in micro abrasion. By providing the adhesive over the entire support region, micro abrasion is prevented or at least reduced.

A tension leg platform comprises a foundation, connected to a bottom of a body of water, a plurality of tendons according to any of the embodiments described above, a buoyant hull, and a topside structure, connected to the buoyant hull and designed to extend above a water level of the body of water, wherein each tendon is connected with the proximal end fitting to the buoyant hull and at the distal end to the foundation to provide a pulling force on the buoyant hull. The tendons pull the buoyant hull towards the foundation, thus increasing the displacement of the buoyant hull such that it is greater than the total weight of buoyant hull and topside structure.

Within the context of this specification, the foundation being connected to the bottom of a body of water is to be understood as any type of connection which enables the tendon to exert the required force on the TLP, including connection by form fit, by friction, by suction, and by weight.

In a first example, the buoyant hull is designed to extend partially below and partially above the water level. In a second example, the buoyant hull is designed to be entirely below the water level.

The topside structure is connected to the hull, for example using coupling means such as nuts and bolt or through welding. In another example, the topside structure and the hull are connected by being formed as a single, integral part.

In a particular embodiment, the topside structure comprises a wind turbine that comprises a mast (also known as ‘tower’). More in particular, the buoyant hull comprises part of the mast, i.e. a lower part of the mast.

In an embodiment, the buoyant hull comprises one body. In another embodiment, the buoyant body comprises a plurality of interconnected bodies.

In an embodiment, the tendons are connected to the buoyant hull via connection means. In particular, the connection means comprise length adjustment means. In particular, the connection means comprise fixed connection members.

In an embodiment, the foundation comprises one or more elements of a list comprising anchor, pile, and counter weight.

### DESCRIPTION OF THE DRAWINGS The invention, its effects, and advantages will be explained in more detail on the basis of the schematic drawings, in which:

FIG. 1 is a schematic drawing of a tension leg platform (TLP) according to a first embodiment of the invention;

FIG. 2 is a schematic drawing of a TLP according to a second embodiment of the invention;

FIG. 3 is a schematic drawing of a TLP according to a third embodiment of the invention;

FIG. 4 shows schematically a cross-section of a tendon according to embodiments of the invention, the cross-section taken along line IV-IV in FIG. 1, and an enlarged detail of said cross-section;

FIG. 5 schematically shows a longitudinal cross-section of a tendon according to a first embodiment of the invention;

FIG. 6 shows schematically a cross-section of the tendon of FIG. 5, taken along line VI-VI in FIG. 5, and an enlarged detail of said cross-section;

FIG. 7 schematically shows a longitudinal cross section of a tendon according to a second embodiment of the invention;

FIG. 8 shows schematically a cross-section of the tendon of FIG. 6, taken along line VIII-VIII in FIG. 7;

FIG. 9 shows a tendon according to a third embodiment of the invention;

FIG. 10 shows a partly exploded section of FIG. 9 along line X-X in FIG. 12;

FIG. 11 shows an enlarged detail from FIG. 10;

FIG. 12 shows a top view of the tendon of FIG. 9;

FIG. 13 shows section XIII-XIII from FIG. 12; and

FIG. 14 shows section XIV-XIV from FIG. 12.

### DETAILED DESCRIPTION

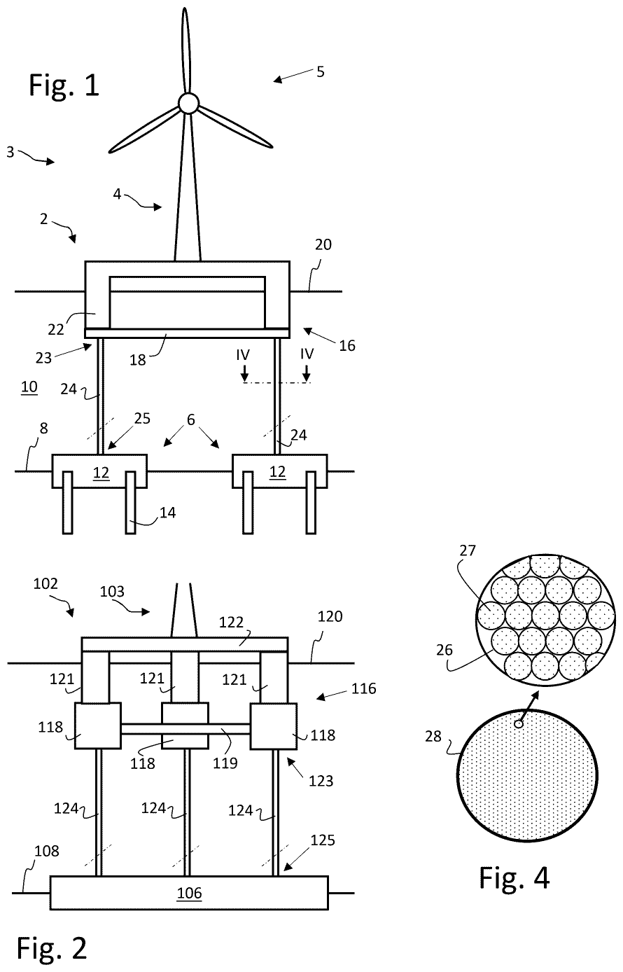

FIG. 1 shows a Tension Leg Platform (TLP), which is denoted in its entirety with reference number 2, that supports a wind turbine 3, with a mast 4, a rotor 5 with a housing and three blades, and a 15 MW generator inside the rotor housing. The 15 MW generator is designed to convert wind energy into electric energy and. The diameter of the rotor with blades of the shown embodiment is 190 meter. The TLP 2 comprises a foundation 6 that is connected to the bottom 8 of a body of water 10. In this embodiment, the foundation 6 is formed by a plurality of concrete blocks 12, acting as counterweight, which are anchored to the seabed 8 by piles 14. The TLP 2 further comprises a buoyant hull 16. In the embodiment of FIG. 1, the hull 16 comprises a pontoon 18 that is provided below the water level 20 and an upper hull structure 22. The pontoon 18 provides buoyancy to the hull 16, e.g. by means of air chambers or by using materials that have a density lower than the density of water. The upper hull structure 22 of this embodiment also provides buoyancy to the hull 16, e.g. by including air chambers in its vertical uprights.

In this embodiment, the topside structure of the TLP 2 is formed by the wind turbine 3 that extends above the water level 20. The rotor is provided at an upper end of the mast at approximately 180 meter above sea water level 10. The wind turbine 3 is mounted to a horizontal top portion of hull 16, formed by a horizontal portion of the upper hull structure 22. The foundation 6 and the buoyant hull 16 are connected by tendons 24. A proximal end 23 of the tendons 24 is connected to the buoyant hull 16 and a distal end 25 of the tendons 24 is connected to the foundation 6 with connections means (not shown). Although FIG. 1 shows tendons 24 for connecting two foundation blocks 12 to the buoyant hull 16, it is understood that any suitable number of foundation blocks 12 and tendons 24 can be used. The current embodiment comprises four foundation blocks 12 at mutual distances of 75 meters. In a variant, more than one tendon 24 can be used per block 12. The tendons 24 are drawn as extending vertically. It is understood that the tendons 24 are provided substantially vertically, such as at an angle of up to 10°. The tendons 24 are not drawn to scale. In particular, the length of the tendons in the illustration is reduced to fit them onto the page, as indicated by the diagonal dash-dot line. In reality, the tendons 24 are at least 300 metres long. In this embodiment, the tendons 24 are 1000 meter each.

FIG. 2 shows a different TLP 102. Also this TLP 102 is used for supporting a wind turbine 103, of which only a part of the mast is illustrated, with a (non shown) rotor having a 18 MW generator. In this embodiment, a foundation 106 is formed as a single element having a triangular shape with sides of 80×80×80 meters. The foundation 106 is fixed to the seabed 108 by its weight. For example, the foundation 106 has chambers that are filled with gravel, sand or concrete to provide it with the necessary weight to keep it on the seabed 108. The TLP 102 further comprises a buoyant hull 116 that comprises fully submerged pontoons 118 and a partially submerged upper hull structure comprising uprights 121 supporting a platform 122. Each upright 121 is mounted on top of one of the pontoons 118. Pontoons 118 are connected to each other via girders 119.

In the embodiment of FIG. 2, three pontoons 118 are present, but it is understood that other embodiments any suitable number of pontoons 118 are provided, e.g. four, six or eight pontoons. In another embodiment, the pontoons 118 are connected to each other in a triangular, square, hexagonal or octagonal arrangement.

A top structure in the form of wind turbine 103 is mounted on top of the buoyant hull 116. As in FIG. 1, the buoyant hull 116 is connected to the foundation 106 via tendons 124, with at least one tendon 124 per pontoon 118. The tendons 124 have a proximal end 123 connected to the hull 116 and a distal end 125 connected to the foundation 106. The tendons 124 of this embodiment have a length of 600 metres.

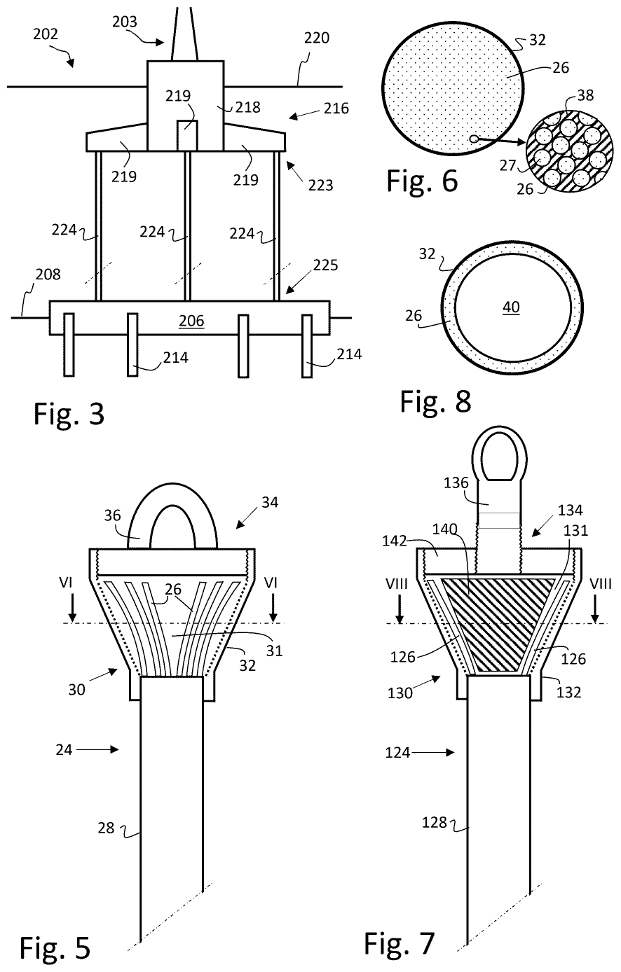

FIG. 3 shows yet another embodiment of a TLP 202, provided with a wind turbine 203 and a foundation 206. The foundation 206 is a single element, as in FIG. 2, has in this embodiment a circular shape with a diameter of 80 meters, and is connected to and ocean floor 208 by piles 214 that have been driven into the soil, as in FIG. 1. The TLP 202 has a buoyant hull 216 that is formed as a central column 218 that provides buoyancy, e.g. by means of an air chamber inside central column 218 or by the use of a material with a density lower than the density of water. The hull 216 further comprises connection means which in this embodiment comprise length adjustment means (not shown) and fixed connection members in the form of girders or arms 219 that are radially spaced out evenly around the central column 218 and connected thereto. Tendons 224 connect the foundation 206 to the buoyant hull 216 via the length adjustments means and each of the arms 219 of the hull 216, with one or more tendons 224 per arm 219. The tendons 224 have a proximal end 223 connected to the hull 216 and a distal end 225 connected to the foundation 206. The tendons 224 have a length of 800 metres.

FIGS. 1-3 show a wind turbine 3, 103, 203 as a topside structure. It is understood that different topside structures can be provided within the scope of the present invention, such as an oil production facility.

A cross-section of one of the tendons 24, 124, 224 of FIGS. 1-3 is shown schematically in FIG. 4 (not to scale). The tendon 24 comprises a plurality of yarns 26 of basalt fibres 27. The yarns 26 are covered by a cover 28 that bundles the yarns 26 into a compact bundle and acts as a protective cover. The cover 28 comprises one or more layers, that for example include a coating and/or sealing tape and/or a braiding.

A design value for the Youngs's modules of basalt is 84 Giga Pascal. As described above, basalt fibres provide approximately 95% of their maximum Young's modulus at low stress values. Therefore, one can add as many basalt fibres as needed to obtain the required stiffness. Therefore, the use of basalt fibres enables producing tendons that have the required length and stiffness for employing TLPs in deep sea, i.e. at least 300 meters deep.

In the embodiment with a tendon 24 of 1000 meters long, a required stiffness is 35 Giga Newton. This results in a tendon with a cross section of 0,605 m² and thus an approximate diameter of 88 cm. In the embodiments with tendons 124 and 224 of shorter length, the cross section is proportionally smaller.

An additional advantage of basalt fibres is that the resulting tendon is much heavier than a tendon made of high performance plastic fibres. Plastic fibres, such as UHMwPE, even provide an upward buoyancy which adds to the total load on the foundation. In contrast, the tendon made of basalt fibres according to the invention is much heavier than water which even decreases the load on the foundation, resulting in a lower design load of the foundation. The above disclosed tendon 24 with a length of 1000 meter and a diameter of 88 cm has an approximate weight of 1200 Ton. Due to this length and diameter of the tendon 24, the difference in load is in the order of magnitude of 1,000 Tons. A further advantage of basalt fibres is that they show virtually no creep, reducing or even eliminating the need to compensate for an elongation of the tendons during use.

A further advantage of using basalt fibres for tendons instead of other types of fibers, such as carbon fibres and plastic fibres, is a significant reduction in costs. For a good comparison, the costs are compared by looking at the costs per meter per meganewton (MN). In other words, one looks at the costs for providing a tendon with a unit of stiffness per unit meter.

The costs for providing a UHMwPE fibre tendon of 1 meter length and a stiffness of 1 MN are 2.5 times greater than the costs for a basalt fibre tendon with the same length and stiffness. The costs for a carbon fibre tendon or a para-aramid fibre tendon (such as marketed under the Twaron® brand) are more than 1.6 times greater than the costs for a basalt fibre tendon.

The costs for the tendons makes up a significant portion of the total construction costs of a TLP. In fact, for tendons comprising carbon or plastic fibres, the costs for the tendons quickly starts to exceed the costs for the platform and wind turbine for increasing lengths of the tendons. Typically, a TLP for a wind turbine has at least three tendons, each tendon for a specific embodiment requires a stiffness of about 35 GN (Giga Newton). If one were to use UHMwPE fibre tendons for such a platform, the costs of the three tendons would be more than four times the costs of the platform and wind turbine. The costs for a tendon of carbon or para-amide fibres would amount to more than 2.8 times the costs of the platform and wind turbine. Notably, the costs of the platform and wind turbine are in the range of tens of millions of euros. It is thus clear that the reduction in costs for tendons by using basalt fibres leads to a significant reduction in the total construction costs of a TLP, particularly with relatively long tendons, e.g. at least 300 meters and in particular 500 meters or 1000 meters.

FIGS. 5 and 6 illustrate a tendon 24 according to a first embodiment of the invention. In this embodiment, both the proximal end 23 and the distal end 25 of the tendon 24 are provided with the same end fitting 30, of which only one is illustrated. The tendon 24 comprises a bundle of yarns 26 (not drawn to scale). The bundle of yarns 26 has been formed by means of pultrusion, wherein a large number of spools with yarns, corresponding to the number of yarns 26 which are required for the tendon, are provided on a rack, and unwound simultaneously by pulling them from the spools. The yarns 26 are bundled together, e.g. by guiding them through a screen with a plurality of holes, and provided with a cover by extruding a polymer such as a thermosetting or thermoplastic epoxy such as polyvinyl chloride (PVC) around the bundle. The resulting bundle of yarns 26 are then cut to the required length. While the yarns 26 are bundled together in the main portion of tendon 24, at the end fitting 30 the yarns 26 are diverging, i.e. gradually fanning out, inside a cavity 31 of a hollow part 32. The walls of cavity 31 are indicated by a dotted line. The cavity 31 has a frustoconical shape which diverges in the direction towards the end of the tendon 24. The cover 28 of the tendon 24 extends partially into the hollow part 32 such that the yarns 26 are not exposed. The outer end of the hollow part 32 is provided with an internal thread, for connection with a threaded endcap 34 that comprises an eyelet 36 for connecting the tendon 24 to the hull 16, 116, 216 or foundation 6, 106, 206 of a TLP 2, 102, 202. The ends of yarns 26 are fixed in their spaced apart configuration by a matrix that fills the cavity 31 inside hollow part 32. The matrix is for example a resin, such as an epoxy resin. For clarity of illustration, the matrix is not shown in FIG. 5. The cross-section of FIG. 6 shows that the hollow part 32 includes a plurality of yarns 26 (drawn as dots to reflect their small dimensions). The enlarged detail of the right hand side of FIG. 6 illustrates the matrix 38 that holds the ends of the yarns 26 in their spaced apart diverging position.

The end fitting 30 can be produced in various ways. In a first example, the yarns 26 are inserted into the hollow part 32 and their ends are spaced apart, after which the cavity 31 is filled with the matrix 38. The end cap 34 is placed after the matrix has hardened. In a second example, the end fitting is produced by feeding the tendon 24 through the hollow part 32 (with end cap 34 not being placed yet) and the exposed ends of the yarns 26 are placed in a mould in a diverging configuration. The mould has a shape that corresponds to the cavity 31 inside the hollow part 32, e.g. frustoconical. The mould is then filled with a matrix, such as an epoxy resin, to form a plug that contains the spaced apart yarn ends. The plug is released from the mould and the tendon 24 is pulled back through the hollow part 32 until the moulded plug fills the cavity 31. Preferably, the moulded plug is then fixated in the cavity 31 by an adhesive, e.g. the same epoxy resin used to form the plug. Finally, the end cap 34 is installed by threading.

FIGS. 7 and 8 illustrates a tendon 124 with an alternative end fitting 130. In this embodiment, both the proximal end 123 and the distal end 125 of the tendon 124 are provided with the same end fitting, of which only one end fitting 130 is illustrated. The tendon 124 comprises a bundle of yarns 126 (not drawn to scale). While the yarns are bundled together in the main portion of tendon 124, at the end fitting 130 the yarns 126 are diverging, i.e. gradually fanning out, inside a cavity 131 of a hollow part 132. The walls of cavity 131 are indicated by a dotted line. The cavity 131 has a frustoconical shape which diverges in the direction towards the end of the tendon 124. The cover 128 of the tendon 124 extends partially into the hollow part 132 such that the yarns 126 are not exposed. Similar to FIG. 5, tendon 124 is inserted into hollow part 132 and the ends of yarns 126 are arranged to diverge inside the cavity 131 of hollow part 132. In this embodiment, an arresting body 140 is inserted into the hollow part 132 to keep the yarns 126 in their spaced apart position. The arresting body 140 has a wedge-shaped form. In this embodiment, the shape corresponds to that of the cavity 131 of the hollow part 132 and is thus frustoconical. While in the embodiment of FIGS. 5 and 6 the yarns 26 are spread throughout the volume of the hollow part 32 (FIG. 6), in FIGS. 7 and 8 the arresting body 140 locks the yarns 126 against the inner wall of the hollow part 132 (FIG. 8). The yarns 126, arresting body 140 and inner wall of the hollow part 132 are interconnected by means of an adhesive (not shown for clarity). One or more layers of yarns 126 may be held between the arresting body 140 and the inner wall of the hollow part 132. An advantage of the embodiment of FIGS. 7 and 8 is that less adhesive is required to fixate the yarns 126 than the amount of epoxy used in the embodiments of FIGS. 5 and 6.

FIG. 7 also shows an alternative embodiment of the end cap 134, with an eyelet 136 that is threaded into an internal threaded portion of a closing nut 142 that closes off the hollow part 132. In a variant, the end cap 134 has a fixed eyelet, such as eyelet 36 of the previous embodiment. In a variant of end cap 34 of the previous, the end cap 34 has an eyelet which is threaded into a closing nut, such as the eyelet 136.

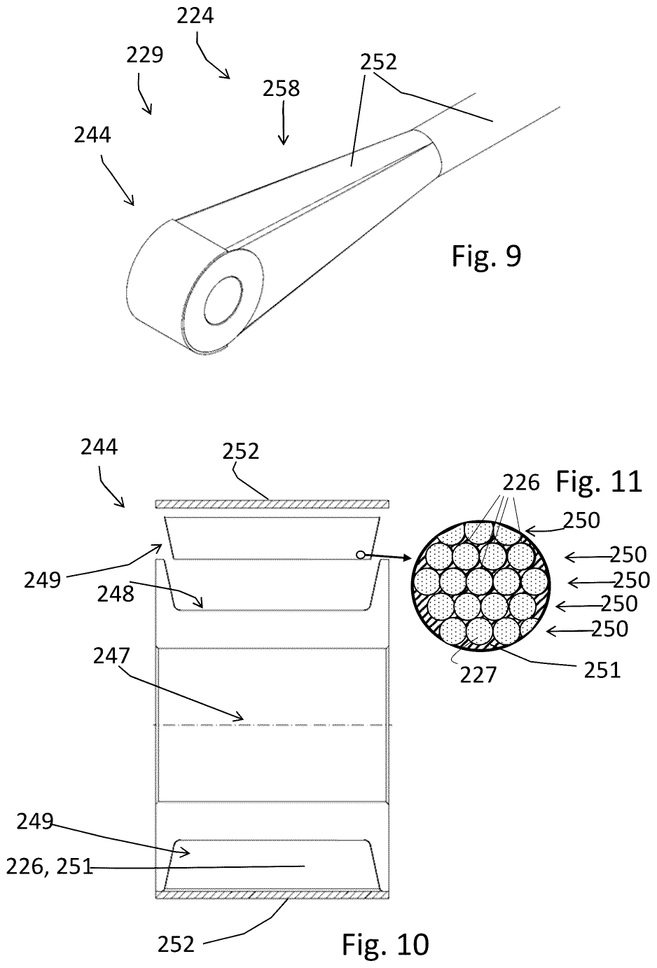

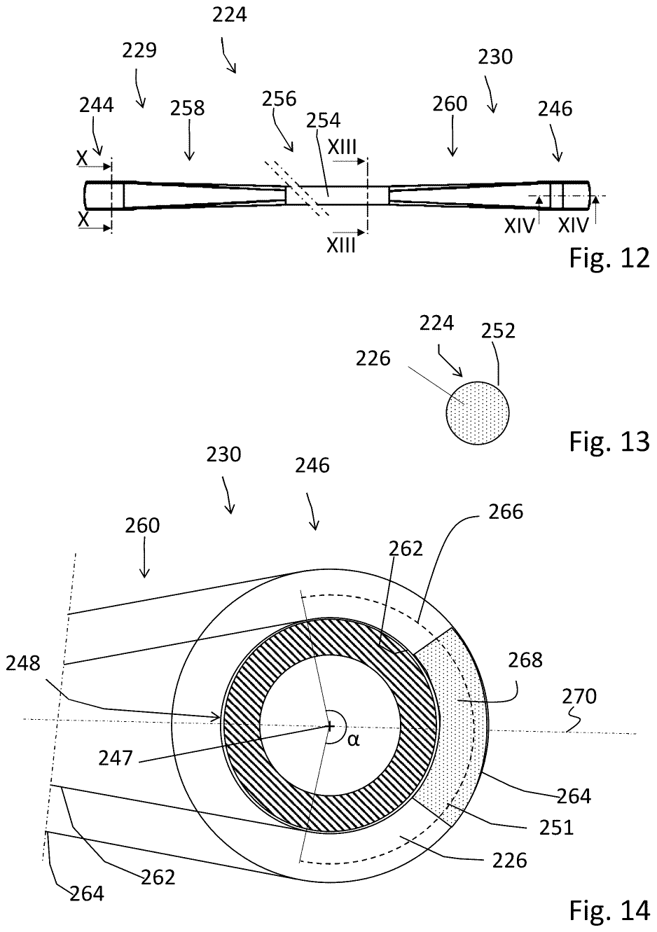

The FIGS. 9-14 show a tendon 224 according to a third embodiment of the invention. The tendon 224 has a proximal end fitting 229, comprising a first thimble 244, a distal end fitting 230, comprising a second thimble 246, and a plurality of yarns 226 comprising basalt fibres. The first 244 and the second 246 thimble are made of stainless steel, are provided at opposite ends of the tendon 224, and each have a centre 247.

The plurality of yarns 226 are in this embodiment twenty-four (24) yarns 226 of 24.000 dtex basalt fibres which all extend from the first 244 to the second thimble 246, turn around the second thimble 246, extend from the second thimble 246 to the first thimble 244, and turn around the first thimble 244. In this manner each of the plurality of yarns 226 forms a semi-continuous loop around the first and second thimbles. This loop is repeated a plurality of times, in this embodiment 9800 times. So each of the yarns 226 makes 9800 turns, resulting in a total of 235.000 turns of yarns 226. As each turn implies two yarns seen in cross section, the total number of yarns in cross section is 470.000.

FIG. 10 shows in cross section that the thimble 244 has a bearing surface 248. The thimble 244 holds a stack 249 with a plurality of layers 250 of turns of the yarn 226. This is shown in more detail in FIG. 11, which is a strongly enlarged and schematic view of five (5) layers 250 of turns of the yarn 226. In the upper part of FIG. 10 the stack 249 is shown in an exploded view for clarity. In reality, the whole stack 249 is held in the first thimble 244 as shown in the lower part of FIG. 10. The second thimble 246 holds layers of the same yarn turns 226 in the same manner and is therefore not shown in detail. The enlarged picture of FIG. 11 also shows that the yarns 226 each comprise a plurality of basalt fibres 227 (indicated as dots in FIG. 11)

A plurality of yarn layers 250 of the tendon 224 is connected to each other by an adhesive, in this embodiment an epoxy resin 251. In this embodiment the epoxy resin 251 is provided at each end fitting 229, 230 for mutually connecting all the layers 250 of turns of the yarn 226 in the stack of each thimble 244, 246, and retaining a tangential orientation of the respective yarn layers 250 with respect to each other when the tendon 224 is rolled up for transport and afterwards subject to a load when used in a TLP, such as one of the TLPs 2, 102, 202.

A cover 252 extends around the tendon 224 from the first thimble 244 to the second thimble 246, and bundles all yarn turns 226 extending between the first and the second thimble 244, 246 in one compact bundle 254 in a middle section 256 of the tendon 224. In this embodiment, the cover 252 also covers the yarn turns 226 at the end fittings 229, 230. The cover 252 creates converging sections 258, 260 of the turns of the yarn 226 which extend from the respective thimble 244, 246 to the middle section 256.

FIG. 13 shows that the tendon 224 in the middle section 256, i.e. between the end fittings 229, 230 is formed by the turns of the yarn 226 without the epoxy resin 251, or any other adhesive, being present between the yarns 226, so that the tendon 224 remains flexible.

FIG. 14 is a schematic longitudinal section through distal end fitting 230. A longitudinal section through proximal end fitting 229 is similar in this embodiment and therefore not shown in detail. It shows the inner contour 262 and outer contour 264 of the converging section 260 of the bundle of yarn turns 226 as it engages and turns around the thimble 246. As the yarn turns 226 are bundled in the middle section 256, and thus split in two halves and diverge towards the thimble 246, they engage in this embodiment an angle a of approximately 220° of the bearing surface 248 of the thimble 246. The region of the bearing surface 248 covered by this angle is referred to as the support region 266, i.e. that part of the thimble's circumference over which the yarns 226 contact, and are supported by, the thimble 246. The support region 266 covers the angle a, as indicated by the dashed line in FIG. 14. In general, an adhesive is applied over a portion 268 of the support region 266. In a preferred embodiment, the portion 268 is substantially the whole support region 266. This results in the yarns 226 being interconnected in the whole support region 266, eliminating movements of the yarns 226 with respect to each other and as a result preventing wear of the basalt fibres which would result in a premature failure of the respective tendon 224.

In an alternative embodiment, the expoxy resin is present in further parts of the respective end fitting, in particular within the whole end fitting.

In an alternative embodiment, the adhesive covers less than half of the support region 268, such as ⅓ of the support region 268 of the distal end fitting 130 as illustrated in FIG. 14. The portion 268 with adhesive is centred about the longitudinal axis 270 of the tendon 224.

The adhesive connects at least two of the plurality of layers of yarns 226, and in the preferred embodiment substantially all layers of yarns are connected by the adhesive 268. Connecting substantially all layers of yarn turns results in an even better increase of life span than connecting just two layers. Within the context of this specification, ‘substantially all layers of yarn turns’ is interpreted as at least 80% of the layers, in particular at least 90% of the layers, more in particular at least 95% of the layers.

In an embodiment, no adhesive is applied at the part of the bearing surface 248 that does not support the turns of yarns 226, i.e. the non-support region that spans the remaining (360°−α) degrees, e.g. the remaining 140° in the example of FIG. 14.

In general, turns of the yarn engage an angle a of the bearing surface of the thimble in a circumferential direction, wherein a is more than 180° and less than 360° of the circumference of the bearing surface of the thimble. In an embodiment, a is more than 200°, in particular more than 220°, and more in particular more than 240°of the bearing surface of the thimble. In an embodiment, a is less than 340°, in particular less than 320°, and more in particular less than 300° of the bearing surface of the thimble.

Several variants are possible within the scope of the attached claims. The features of the above described preferred embodiment(s) may be replaced by any other feature within the scope of the attached claims, such as the features described in other embodiments, and in the following paragraphs.

Each type of tendon 24, 124, 224 described above can be used by itself or in combination with other types of tendons, such as one of the other disclosed tendons 24, 124, 224 or tendons of a type not disclosed in this specification, in any one of the TLPs 2, 102, 202 described above or in other TLPs. In other words, in embodiments, a TLP 102 or TLP 202 is provided with a tendons 24, a TLP 2 or TLP 202 is provided with tendons 124, or a TLP 2 or TLP 102 is provided with tendons 224.

A tendon according to the invention may be made of more or less than ten yarns, such as one yarn, two yarns, or at least five yarns. The total number of yarn turns, i.e.

yarn turns per layer and number of layers, depends on the required strength and stiffness of the tendon, and the strength of one individual yarn, as well as the required safety margin. The number of layers depends on the required number of yarn turns, and the available width in the thimble resulting in a maximum number of yarn turns in the width direction.

In an embodiment, yarn layers in only one of the thimbles is provided with an adhesive. In particular, one thimble of such an embodiment differs from the other thimble such that an adhesive is less beneficial, e.g. if the load on the fibres is smaller due to a larger radius and/or larger width of the respective thimble.

In an embodiment, adhesive is applied to the tendon between the thimbles such, that the tendon between the thimbles remains flexible. An tendon is considered to be flexible if it is capable of being rolled up, e.g. for transport. Such flexibility is present if the different layers of turns of the yarn in the tendon between the thimbles are able to shift with respect to each other in their longitudinal direction. In particular, adhesive is applied to the tendon extending between the thimbles, but not cured and/or adhesive is applied and cured to a minor portion of the tendon only such, that the tendon as a whole remains flexible. In an embodiment, adhesive is present to connect layers of the cover around the yarns of the tendon.

In an embodiment, a tendon comprises more than two thimbles. In such an embodiment, at least two thimbles are present at one end of the tendon. Two thimbles in one end fitting form a female end fitting, so that a connection with a further flexible tendon can be established by putting a male end fitting between the thimbles of the female end fitting.

In an embodiment, another type of resin may be used, such as a polyester resin, vinyl ester resin, or polyamide. In particular, the resin is a thermosetting polymer.

In an embodiment, the adhesive is applied at one of the thimbles only.

In an embodiment, the adhesive is applied at the thimble(s) of one or both of the end fittings only, and not in the converging sections of the turns of the yarn in the end fitting.

In an embodiment, the adhesive is applied during the process of winding the yarn(s), i.e. adhesive is applied on top of each layer of yarns turns, or on top of every nth layer of yarn turns, wherein n is an integer and equal to or larger than one (1), and smaller than the total number of yarn turns in the stack.

In an embodiment, the adhesive is cured by adding a hardener, such as a polyamine hardener for a resin. In another embodiment, the adhesive is cured by means of radiation, such as IR radiation, UV radiation, or micro wave radiation.

In an embodiment, the thimble is made of a plastic material instead of a metal, or of a different metal than stainless steel, including but not limited to different steel alloys, aluminium alloys, magnesium alloys, and titanium.

In several embodiments, a tendon is formed by pultrusion resulting in a tendons with yarns with a finite length. Pultrusion processes commonly include wetting fibres in a resin before they are covered. While this wetting results in a tendon which is suitable for some applications, it could result in a tendon which is too stiff and cannot be bended for transport. In a preferred embodiment a tendon is made by dry pultrusion, i.e. without wetting the fibres before they are bundled. This ensures a movability of the fibres with respect to each other which enables the tendon to be rolled up for transport.

In a variant, the yarns are bundled with a braided cover in addition to, or instead of, a PVC cover. In a variant, the yarns are bundled with a tape, in particular a helically wound tape, in addition to, or instead of, a PVC cover and/or a braided cover.

In an embodiment a tendon is made of a plurality of sub ropes, each sub rope being produced by pultruding basalt yarns. The yarns in the sub ropes are untwisted, and the sub ropes are provided parallel to each other, i.e. without twist, in the tendon, and held together by a cover, such as one or more of the above disclosed covers.

It is noted that British spelling is applied in the above specification for terms such as ‘fibre’, ‘mould’, and ‘centre’. These terms can be replaced for the relevant US type of spelling, ‘fiber’, ‘mold’, and ‘center’ without changing the content of this specification.

1. A tendon for a tension leg platform wherein the tension leg platform has a foundation connectable to a bottom of a body of water and a buoyant hull, the tendon comprising:
a proximal end, a distal end, a length between the proximal end and the distal end of at least 300 meters, a proximal end fitting at the proximal end, and a distal end fitting at the distal end,
wherein the tendon is connectable with the proximal end fitting to the buoyant hull. and is connectable with the distal end fitting to the foundation to provide a pulling force on the buoyant hull, and
wherein the tendon comprises basalt fibers for transferring the pulling force from the proximal end fitting to the distal end fitting.

2. The tendon for a tension leg platform according to claim 1, wherein the tendon defines a longitudinal direction along the length, and wherein the basalt fibers extend parallel to each other in the longitudinal direction of the tendon.

3. The tendon for a tension leg platform according to claim wherein the basalt fibers are untwisted.

4. The tendon for a tension leg platform according to claim 1 wherein the tendon comprises a plurality of yarns comprising the basalt fibers, each of the plurality of yarns has a length which corresponds to the length of the tendon and has a proximal yarn end which is connected to the proximal end fitting and a distal yarn end which is connected to the distal end fitting.

5. The tendon for a tension leg platform according to claim 4, wherein at least one of the distal end fitting or the proximal end fitting comprises a hollow part that has a cavity of which the width increases towards the respective end of the tendon and wherein the yarns extend into the cavity of the hollow part and diverge inside the cavity.

6. The tendon for a tension leg platform according to claim 5, wherein the cavity comprises a frustoconical shape.

7. The tendon for a tension leg platform according to claim 5, wherein the cavity is filled with a matrix that fixates the diverging yarns.

8. The tendon for a tension leg platform according to claim 5, wherein an arresting body that keeps the diverging yarns spaced apart is provided in the cavity.

9. The tendon for a tension leg platform according to claim 4, wherein the tendon is formed by pultrusion to bundle the basalt yarns with a cover.

10. The tendon for a tension leg platform according to claim 1, wherein the tendon comprises at least one yarn which comprises the basalt fibers,
the proximal end fitting comprises a first thimble and the distal end fitting comprises a second thimble,
the first thimble and the second thimble are provided at opposite ends of the tendon, and
the at least one yarn extends from the first thimble to the second thimble turns around the second thimble extends from the second thimble to the first thimble and turns around the first thimble such that the yarn forms turns around the first and second thimbles and each thimble holds a stack of a plurality of layers of turns of the yarn.

11. The tendon for a tension leg platform according to claim 10, wherein an adhesive is provided at at least one of the first and second thimble only and mutually connects at least two of the plurality of layers of turns of the yarn in the stack of the respective first or second thimble to retain a tangential orientation of the respective yarn layers with respect to each other when the tendon is subject to a load, wherein the stack of the plurality of turns of the yarns of each thimble engages the respective thimble along a part of the respective thimble's circumference, and wherein the adhesive provided at said at least one of the first and second thimble extends over at least a portion of said circumferential part of the respective first or second thimble.

12. The tendon for a tension leg platform according to claim 11, wherein the adhesive extends over the entire circumferential part of the respective first or second thimble.

13. The tendon for a tension leg platform according to claim 11, wherein the adhesive extends over only the portion of the circumferential part of the respective first or second thimble.

14. A tension leg platform comprising
a foundation connected to a bottom of a body of water,
a plurality of tendons according to claim 1,
a buoyant hull, and
a topside structure connected to the buoyant hull and designed to extend above a water level of the body of water, wherein
each tendon is connected with the proximal end fitting to the buoyant hull and with the distal end fitting to the foundation to provide a pulling force on the buoyant hull.

15. The tension leg platform according to claim 14, wherein the topside structure comprises a wind turbine.

16. The tension leg platform according to claim 15, wherein the wind turbine comprises a mast and the buoyant hull comprises part of the mast.

17. A tension leg platform, comprising:
a foundation, connected to a bottom of a body of water,
a plurality of tendons, according to claim 4,
a buoyant hull, and
a topside structure, connected to the buoyant hull and designed to extend above a water level of the body of water, wherein
each tendon is connected with the proximal end fitting to the buoyant hull and with the distal end fitting to the foundation to provide a pulling force on the buoyant hull.

18. The tension leg platform according to claim 17, wherein the topside structure comprises a wind turbine.

19. A tension leg platform, comprising:
a foundation, connected to a bottom of a body of water,
a plurality of tendons, according to claim 10,
a buoyant hull, and
a topside structure, connected to the buoyant hull and designed to extend above a water level of the body of water, wherein
each tendon is connected with the proximal end fitting to the buoyant hull and with the distal end fitting to the foundation to provide a pulling force on the buoyant hull.

20. The tendon for a tension leg platform according to claim 5, wherein an arresting body having a shape that is complementary to a shape of the cavity is provided in the cavity and is configured to keep the diverging yarns spaced apart.

21. The tendon for a tension leg platform according to claim 11, wherein the adhesive extends over only the portion of the circumferential part of the respective first or second thimble that is centered about the longitudinal axis of the tendon.
